(19) United States
(12) Patent Application Publication
(10) Pub. No.: US 2022/0035925 A1
(43) Pub. Date: Feb. 3, 2022

(54) RECOVERY FROM LOST CREDENTIALS FOR PRE-BOOT AUTHENTICATION

(71) Applicant: Quick Heal Technologies Limited, Pune (IN)

(72) Inventor: Niraj Kumar Jha, Pune (IN)

(21) Appl. No.: 16/947,967

(22) Filed: Aug. 26, 2020

(30) Foreign Application Priority Data
Jul. 29, 2020 (IN) 202021032453

(51) Int. Cl. G06F 21/57; G06F 21/60; G06F 21/31

(52) U.S. Cl. CPC G06F 21/575; G06F 21/31; G06F 21/602

(57) ABSTRACT

A digital processing system receives, in a pre-boot duration, an indication from a user to retrieve a credential required for booting the digital processing system. The digital processing system connects, in the pre-boot duration, to a user device and retrieves, in the pre-boot duration, the credential from an external server using the user device. Booting is thereafter continued. In an embodiment, a BIOS (basic input/output system) software performs the receiving, the connecting, the retrieving, and completes the booting upon initialization of the digital processing system.

### PRIORITY CLAIM

The instant patent application is related to and claims priority from the co-pending India nonprovisional patent application entitled, “RECOVERY FROM LOST CREDENTIALS FOR PRE-BOOT AUTHENTICATION”, Serial No.: 202021032453, Filed: 29 Jul. 2020, which is incorporated in its entirety herewith.

### BACKGROUND OF THE DISCLOSURE

### Technical Field

The present disclosure relates to pre-boot authentication, and more specifically to recovery from lost credentials for pre-boot authentication.

### Related Art

Booting a digital processing system (such as laptop, desktop, personal computer, etc.) refers to the process of loading operating system into an execution environment (e.g., random access memory), which thereafter permits digital processing systems to perform their normal intended operations (e.g., running of user applications).

Booting is commonly performed upon initialization of digital processing systems such as powering-up or restarting, as is well known in the relevant arts. Thus, the period prior to start of loading of the operating system is referred to as a pre-boot duration.

Authentication is often required in pre-boot durations. Authentication generally entails receiving the corresponding credentials and permitting the booting process to continue upon receipt of valid credentials. For example, a system may require authentication of a user by appropriate credentials in permitting the booting process to continue. The credentials may correspond to a password in an example scenario.

There is often the risk of credentials being lost/forgotten. At least in such cases, a recovery mechanism is required for continuing with the booting process. Aspects of the present disclosure provide for recovery from lost credentials for pre-boot authentication.

### BRIEF DESCRIPTION OF THE DRAWINGS

Example embodiments of the present disclosure will be described with reference to the accompanying drawings briefly described below.

FIG. 1 is a block diagram illustrating an example environment (computing system) in which several aspects of the present disclosure can be implemented.

FIG. 2 is a block diagram illustrating the manner in which recovery from lost credentials for pre-boot authentication is implemented in an embodiment.

FIG. 3 is a block diagram illustrating the details of a client system and a user device in one embodiment.

FIG. 4 depicts a sample password table in an embodiment.

FIG. 5A is a flow chart illustrating an example approach by which a server system aids in recovery from lost password in an embodiment.

FIG. 5B is a flow chart illustrating another example approach by which a server system aids in recovery from lost password in an embodiment.

FIG. 6A is a frame flow diagram illustrating the sequence of interactions for recovery from lost password in the first example approach.

FIG. 6B is a frame flow diagram illustrating the sequence of interactions for recovery from lost password in the second example approach.

FIG. 7 is a block diagram illustrating the details of a digital processing system in which several aspects of the present disclosure are operative by execution of appropriate software instructions.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE EMBODIMENTS OF THE DISCLOSURE

### 1. Overview

A digital processing system provided according to an aspect of the present disclosure receives, in a pre-boot duration, an indication from a user to retrieve a credential required for booting the digital processing system. The digital processing system connects, in the pre-boot duration, to a user device and retrieves, in the pre-boot duration, the credential from an external server using the user device. Booting is thereafter continued.

According to another aspect, software instructions representing an operating system are stored in an encrypted format as a first cipher data on a secondary storage. Accordingly, the first cipher data is decrypted utilizing the credential to generate the software instructions. The decrypted software instructions are executed to have operating system be operational in the digital processing system.

In an embodiment, a BIOS (basic input/output system) software performs the receiving, the connecting, the retrieving, the decrypting of the first cipher data, and completes the booting upon initialization of the digital processing system.

According to one more aspect, the credential is a rescue password in which software instructions are first encrypted using a first key as encryption key. The first key is encrypted using the rescue password as encryption key to generate a second cipher data, wherein the decrypting first decrypts the first key by processing the second cipher data using the rescue password as a decryption key, and then the first cipher data is processed using the decrypted first key as decryption key to generate the software instructions.

According to yet another aspect, the BIOS retrieves the credential, performs the decrypting and the executing without requiring further user input after receipt of the indication.

In an embodiment, multiple cipher data, including the second cipher data and a third cipher data, are stored in the form of a table, wherein each cipher data represents encrypted form of the first key based on a corresponding password, and the third cipher data represents encrypted form of the first key using a normal password which can be entered by the user in the pre-boot duration for booting the digital processing system. The user provides the indication upon unavailability of the normal password to cause the rescue password to be retrieved and boot the digital processing system.

According to another aspect, the credential comprises a current biometric information of the user. To retrieve the credential, the digital processing system authenticates the user device and then receives the current biometric information of the user from the user device, wherein the user device acquires and provides the current biometric information to the digital processing system only after receipt of a consent from the central server based on confirmation that the digital processing system is paired to the user device. Booting is continued upon the current biometric information matching a prior biometric information of the user.

Several aspects of the present disclosure are described below with reference to examples for illustration. However, one skilled in the relevant art will recognize that the disclosure can be practiced without one or more of the specific details or with other methods, components, materials and so forth. In other instances, well-known structures, materials, or operations are not shown in detail to avoid obscuring the features of the disclosure. Furthermore, the features/aspects described can be practiced in various combinations, though only some of the combinations are described herein for conciseness.

### 2. Example Environment

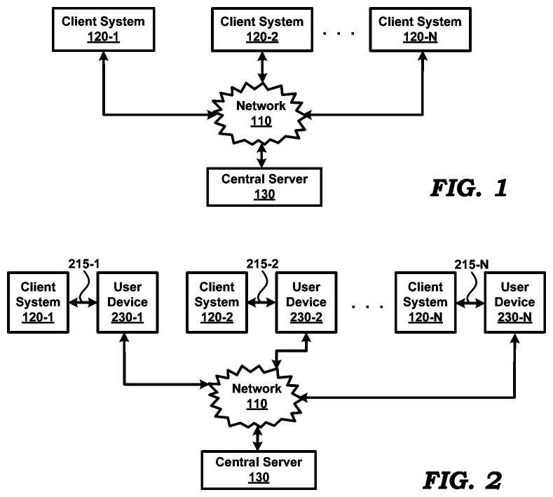

FIG. 1 is a block diagram illustrating an example environment (computing system) in which several aspects of the present disclosure can be implemented. The block diagram is shown containing network 110, client systems 120-1 to 120-N (N representing any arbitrary positive number) and central server 130. Client systems 120-1 to 120-N are collectively or individually referred by referral numeral 120, as will be clear from the context. Similar convention is used in the description related to other blocks of various Figures as well.

Merely for illustration, only representative number/type of systems are shown in FIG. 1. Many environments often contain many more systems, both in number and type, depending on the purpose for which the environment is designed. Many instances of central server 130 and may be provided in a cloud infrastructure. Each block of FIG. 1 is described below in further detail.

Network 110 provides connectivity between client systems 120-1 to 120-N and central server 130, and may be implemented using protocols such as Transmission Control Protocol (TCP) and/or Internet Protocol (IP), well-known in the relevant arts. In general, in TCP/IP environments, a TCP/IP packet is used as a basic unit of transport, with the source address being set to the TCP/IP address assigned to the source system from which the packet originates and the destination address set to the TCP/IP address of the target system to which the packet is to be eventually delivered.

An IP packet is said to be directed to a target system when the destination IP address of the packet is set to the IP address of the target system, such that the packet is eventually delivered to the target system by network 110. When the packet contains content such as port numbers, which specifies the destination application, the packet may be said to be directed to such application as well. The destination system may be required to keep the corresponding port numbers available/open, and process the packets with the corresponding destination ports. Network 110 may be implemented using any combination of wire-based or wireless mediums.

Each of client systems 120-1 to 120-N represents a corresponding end user system such as a personal computer, workstation, laptop, etc., which requires authentication in the pre-boot duration. Each of client systems 120-1 to 120-N may also represent a corresponding virtual machine. Each of client systems 120-1 to 120-N may be a part of enterprise computing environment or a stand-alone system.

Central system 130 represents a server system which may aid client systems in recovery from lost credentials for pre-boot authentication. In an embodiment, central system 130 operates to provide centralized security/encryption policy management for client systems 120-1 to 120-N in an enterprise computing environment. For example, a typical enterprise contains many client systems 120 and many applications may be running on central server 130. Enterprise-level security and authentication policies may be provided by central server 130.

Central system 130 operates in conjunction with user devices associated with client systems 120 for convenient recovery from lost credentials, according to aspects of the present disclosure, as described below in further detail.

### 3. Recovery from Lost Credentials Broadly

FIG. 2 is a block diagram illustrating the manner in which recovery from lost credentials for pre-boot authentication is implemented in an embodiment. The block diagram of FIG. 2 is shown containing user devices 230-1 to 230-N respectively coupled to client systems 120-1 to 120-N via corresponding communication paths 215-1 to 215-N. Central server 130 is shown in addition. The description of the components of FIG. 1 is not repeated for conciseness.

Network 110 provides connectivity between user devices 230-1 to 230-N and central server 130. As noted above with respect to FIG. 1, network 110 may be implemented using protocols such as Transmission Control Protocol (TCP) and/or Internet Protocol (IP).

In the examples described herein, each of user devices 230-1 to 230-N represents a corresponding user mobile device such as a smart phone, tablet, etc. Each client system 120 may be associated with a user, who in turn may be linked to at least one user device 230.

Communication path 215 provides connectivity between each client system 120 and respective user device 230, and may be implemented using wired (such as USB) or wireless protocols (such as IEEE 802.11 protocol), well-known in the relevant arts.

In general, wireless local area networks (WLANs) based on IEEE 802.11 protocols, are used for wireless communication between devices within a limited area (e.g. home, school, office building). A frame is the basic unit of transport in IEEE 802.11 protocol, with the source address being set to the MAC address assigned to the source system from which the frame originates and the destination address set to the MAC address of the target system to which the frame is to be eventually delivered. A wireless network may operate with or without an access point, as will be apparent to the skilled practitioner.

Thus, during operation, client system 120 may be initialized and situations may be presented when the requisite credentials for the boot operation are not available. Accordingly, in a pre-boot duration on client system 120, an indication is received from a user to retrieve a credential required for booting client system 120. Upon receipt of such an indication, client system 120 connects to user device 230 on communication path 215 in the pre-boot duration. The credential is retrieved from central server 130 in the pre-boot duration using user device 230. After receipt of the credential, the booting process is continued on client system 120.

While client system 120 is shown communicating with central server 130 only via user device 230 using network 110 in FIG. 2 for the purpose of recovery from lost credentials, it may be appreciated that alternative embodiments may provide for direct communication between client system 120 and central server 130 (via network 110) at least in some aspects of recovery from lost credentials, as will be apparent to a skilled practitioner.

The description is continued with respect to the details of the various blocks of FIG. 2 for implementing recovery from lost credentials in an example implementation.

### 4. Example Implementation

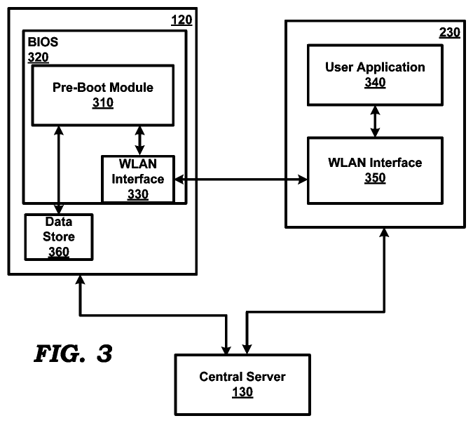

FIG. 3 is a block diagram illustrating the details of a client system and a user device in one embodiment. The block diagram is shown containing client system 120, user device 230 and central server 130. Client system 120 is shown containing BIOS (Basic Input Output System) 320 and data store 360. BIOS 320 in turn is shown containing pre-boot module 310 and WLAN (Wireless Local Area Network) interface 330. User device 230 is shown containing user application 340 and WLAN interface 350. Each of the blocks of FIG. 3 is described in detail below.

BIOS 320 is generally the first executable module to be invoked upon initialization (power-up or reboot) of client system 120, with the primary purpose of loading the operating system into executable space (RAM), as is well known in the relevant arts. BIOS 320 may also be used to perform other actions such as hardware initialization, managing communication between the operating system (OS) and attached devices such as hard disk, keyboard, mouse, printer, etc. Execution modules representing BIOS may be stored on non-volatile memory (such as EEPROM) on client system 120 and executed upon initialization of the client system 120. In an embodiment, BIOS 320 represents UEFI (Unified Extensible Firmware Interface) firmware.

Pre-boot module 310 operates to authenticate users in the pre-boot duration. In an embodiment, pre-boot module 310 executes as part of DXE (Driver Execution Environment) phase of the UEFI booting process, as is well-known in the relevant arts. Pre-boot module 310 may access data in data store 360 in order to perform pre-boot authentication.

Data store 360 represents a non-volatile (persistent) storage facilitating storage and retrieval of a collection of data by pre-boot module 310. In an embodiment, data store 360 may be implemented as secondary memory (e.g. hard disk) of client system 120.

WLAN interfaces 330 and 350 facilitate wireless communication of client system 120 and user device 230 respectively with external systems even in the pre-boot duration. WLAN interface 350 may provide connectivity of user device 230 to the internet.

User application 340 represents one of the several software applications executed on user device 230 to process user requests. In an embodiment, user application 340 operates in conjunction with central server 130 to aid recovery from lost credentials on client system 120.

It may be appreciated that the various techniques disclosed herein are described below with respect to IEEE 802.110-based wireless networking merely for illustration. However, as will be apparent to a skilled practitioner, the teachings disclosed herein may be implemented in other wireless networks. Accordingly, references to techniques and components specific to IEEE 802.11 apply equivalently to the corresponding elements in other wireless network standards.

The example implementation could work with various types of credentials. Merely for ease of understanding, the credentials correspond to a password in the illustrative embodiments described below.

### 5. Example Password Management

Pre-boot authentication is often employed when the hard disk (including the operating system) is encrypted, as is well known in the relevant arts. Disk encryption schemes may employ a disk-encryption-key in order to encrypt the hard disk. The credentials received during pre-boot duration may operate to safeguard the disk-encryption-key (DEK). In other words, the disk-encryption-key itself may be encrypted using the pre-boot authentication credentials to generate a DEK cipher data. Thus, pre-boot authentication credentials may be utilized to decrypt the DEK cipher data and generate (by decrypting) software instructions representing the operating system.

In an embodiment, client system 120 may be part of an enterprise environment which provides disk encryption of client systems 120-1 to 120-N. Accordingly client system 120 may require a password for pre-boot authentication.

It may be appreciated that client system 120 may be associated with multiple users at different times (e.g. a laptop/work station may be allocated to a new employee when a former employee leaves the enterprise). Also, each client system 120 may be operated by administrative staff when such assistance is required (e.g. at the time of installing new software, etc.). Thus, a user of a client system 120 may be an admin (super user) or an employee (limited user). Accordingly, each user may provide his/her password for pre-boot authentication.

A master password is a password used for pre-boot authentication configured by and known only to the super user of client system 120. The master password may be configured for the first time by super user at the time of installing pre-boot module 310 on client system 120. Subsequently, the master password may be reset, as is well known in the relevant arts.

Additional passwords (or normal passwords) for pre-boot authentication may be configured by limited users who may be allocated client system 120. Additional passwords may be configured by limited users the first time they access client system 120. Each limited user of client system 120 may provide only one additional password.

A rescue password is a password used for aiding the pre-boot authentication when master password and/or additional passwords are lost/forgotten. The rescue password is generated by pre-boot module 310 as described below in detail.

Pre-boot module 310 may use each of the master password, the rescue password and additional passwords as different encryption keys to encrypt the disk-encryption-key using a symmetric encryption scheme, and stores the resulting respective cipher data in a password table in data store 360.

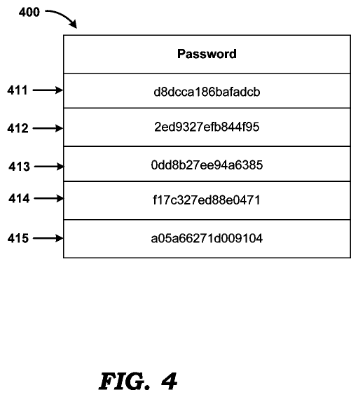

FIG. 4 depicts a sample password table in an embodiment. Specifically, table 410 is shown with 5 rows 411-415. Column “Password” specifies cipher data generated by encrypting disk-encryption-key using various passwords as encryption keys.

In an embodiment, row 411 specifies the cipher data generated using master password, row 412 specifies the cipher data generated using rescue password and rows 413-415 specify cipher data generated using additional passwords (assuming three users are supported).

Disk encryption may be performed for the first time upon installing pre-boot module 310 on client system 120. Disk encryption may also be performed in other instances such as re-generation of rescue password, as described below in detail.

In an example embodiment, upon receiving the master password from super user of client system 120, pre-boot module 310 generates a 32-bit intermediate-key using random encoding technique. As a next step, pre-boot module 310 generates a 32-bit hash (intermediate-key-hash) from the intermediate-key using well known cryptographic hash functions. Pre-boot module 310 stores the concatenated 64-bit value (intermediate-key and intermediate-key-hash) as the disk-encryption-key in data store 360 of client system 120.

Simultaneously, pre-boot module 310 also generates the rescue password in the form of a GUID (Globally Unique Identifier) using the intermediate-key. Pre-boot module 310 sends the rescue password to central server 130 on network 110 along with a unique identifier for client system 120. Thus, central server 130 may store rescue password associated with each client system 120.

As a next step, pre-boot module 310 may encrypt hard disk of client system 120 using disk-encryption-key and store the resulting cipher data in data store 360.

When a user tries to boot client system 120, pre-boot module 310 challenges the user for password as part of pre-boot authentication via a suitable user interface. Thus, a super user is expected to provide the master password and a limited user is expected to provide the additional password for pre-boot authentication. Pre-boot module 310 uses the password provided by the user to decrypt the cipher data in all the rows 411-415 in table 400. If any of the decrypted values matches with the disk-encryption-key retrieved from data store 360, pre-boot module 310 concludes that the boot request is received from an authorized user and continues with the boot process.

In an alternative embodiment, the two halves comprising the disk-encryption-key (i.e. the intermediate-key and the intermediate-key-hash) may be encrypted separately using each of the master password, the rescue password and additional passwords as different encryption keys. The resulting cipher data may be stored in table 400. Accordingly, when a user provides password during pre-boot authentication, pre-boot module 310 may decrypt all the rows 411-415 representing the cipher data corresponding to the first half (intermediate-key) using the password. Upon a match of the decrypted value with the stored first half, pre-boot module 310 may generate a first hash of the decrypted first half using the same hashing function as noted above. Pre-boot module 310 may then decrypt the cipher data corresponding to the second half (intermediate-key-hash) using the password. If the generated first hash and the intermediate-key-hash values match, pre-boot module 310 may conclude that the request is received from an authorized user and allows the booting process to continue.

In an embodiment, pre-boot module 310 may encrypt a constant string using each of the master, rescue and additional passwords and store the encrypted values in data store 360. When a password is provided by user during pre-boot authentication, pre-boot module 310 may first validate the password received from the user by decrypting the encrypted values. If any of the decrypted values matches with the constant string, pre-boot module 310 may then proceed with further decryption of the disk-encryption-key as described above.

It may be appreciated that the above approach is one of the ways of performing disk encryption. However, alternative ways of encrypting/decrypting the hard disk (e.g. using different key-lengths/encryption algorithms/hashing functions, etc) will be apparent to a skilled practitioner without departing from the scope and spirit of several aspects of the present invention, by reading the present disclosure.

In an embodiment, when the password provided by the super user/limited user is incorrect (pre-boot module 310 is unable to find a match of the decrypted value with the disk-encryption-key), pre-boot module 310 increments an invalid-password-counter. The invalid-password-counter is a value stored in data store 360 of client system 120. Pre-boot module 310 maintains a single invalid-password-counter for all users of client system 120. In other words, if the super user provides incorrect password 2 times when trying to boot client system 120 and a limited user provides incorrect password 3 times, then the value stored in the invalid-password-counter is 5.

When the value of the invalid-password-counter exceeds a certain threshold (e.g. 10), then pre-boot module 310 locks client system 120 and does not permit the user to provide any more password attempts to proceed with the boot process.

When the user has forgotten his password or has been locked out, a recovery mechanism is required to continue with the boot process. Pre-boot module 310 may provide the user with a suitable user interface to initiate the recovery process. The user may then indicate to client system 120 to retrieve a credential required for booting.

The description is continued with respect to the manner in which pre-boot module 310 operates in conjunction with user device 230 to retrieve rescue password from central server 130 for recovery from lost password, in accordance with features of the present disclosure.

### 6. Recovery from Lost Password Using Rescue Password

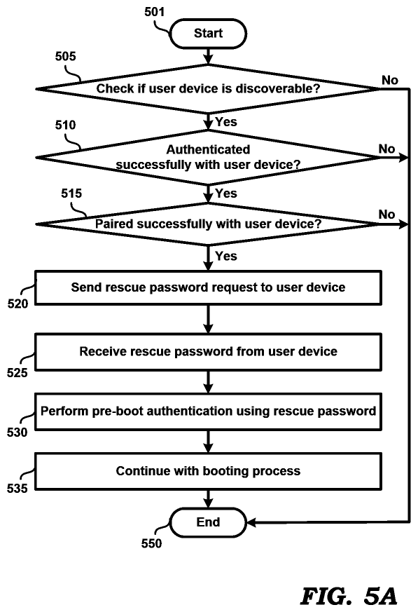

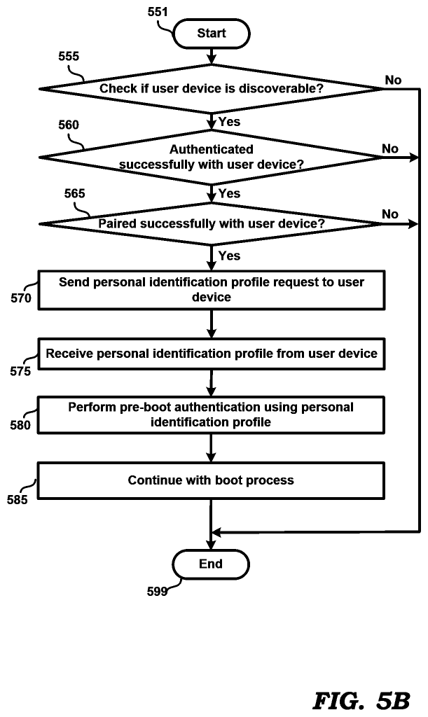

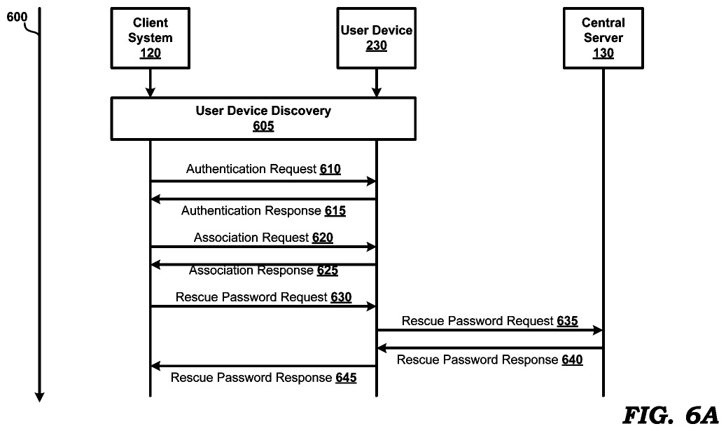

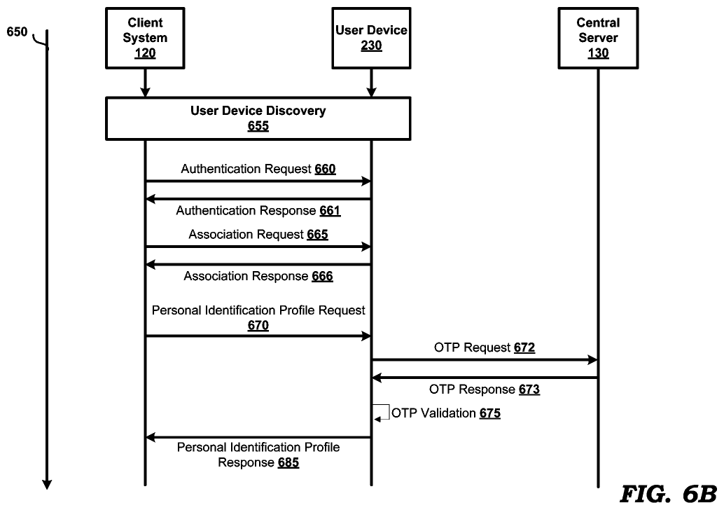

FIGS. 5A and 6A together illustrate the manner by which a server system aids in recovery from lost password in an embodiment. Specifically, FIG. 5A is a flowchart illustrating a first example approach for recovery using rescue password. FIG. 6A is a frame flow diagram illustrating the corresponding sequence of interactions for such recovery. Element 600 in FIG. 6A depicts the timeline for the sequence of interactions. All communication frames between client system 120 and user device 230 may be sent/received via WLAN interface 330 on client system 120 and WLAN interface 350 on user device 230.

The flowchart and frame flow diagram are described with respect to the systems of FIGS. 2 and 3 merely for illustration. However, many of the features can be implemented in other systems and/or other environments also without departing from the scope and spirit of several aspects of the present disclosure, as will be apparent to one skilled in the relevant arts by reading the disclosure provided herein.

In addition, some of the steps may be performed in a different sequence than that depicted below, as suited to the specific environment, as will be apparent to one skilled in the relevant arts. Many of such implementations are contemplated to be covered by several aspects of the present disclosure.

The flow chart of FIG. 5A begins in step 501 upon receiving an indication from the user that the rescue password needs to be retrieved for booting, in which control immediately passes to step 505.

In step 505, client system 120 checks if user device 230 is discoverable. This is implemented in user device discovery phase 605 of FIG. 6A. User device 230 may transmit/broadcast frames such as probe request/active scan frames containing the MAC address of user device 230 to facilitate client system 120 to discover the corresponding associated user device 230. When user device 230 is within a certain range (e.g. 200 m), client system 120 may be able to listen to the frames broadcast by user device 230 via WLAN interface 330.

As part of configuring client system 120 for a user, the MAC address of user device 230 coupled with client system 120 may be provided to pre-boot module 310. Pre-boot module 310 may store the MAC address in data store 360. Pre-boot module 310 may check for a match of MAC address in the frames with the stored MAC address. If a match is detected, pre-boot module 310 may try to authenticate with user device 230. Control passes to step 510 if device discovery is successful (value “YES”) and to step 550 otherwise.

In step 510, client system 120 checks if authentication with user device 230 is successful. Referring now to FIG. 6A, pre-boot module 310 on client system 120 sends authentication request 660 to user device 230. Authentication request 660 may correspond to authentication request frame in accordance with IEEE 802.11 protocol, as is well known in the relevant arts. User application 340 on user device 230 may process authentication request 660.

In an embodiment, client system 120 authenticates user device 230 using shared key authentication technique (e.g. a PIN). The PIN may be configured by super user on client system 120 and stored in data store 360. The same PIN may also be configured on user application 340 of user device 230.

It may be appreciated that the PIN may not be a constant/fixed value and may have different values at different times based on a rotation policy. The rotation policy details/updates may be provided to client system 120 by central server 130.

Referring again to FIG. 6A, user application 340 on user device 230 may send authentication response 615 containing the PIN to client system 120. Pre-boot module 310 may check for a match of the received PIN with the stored PIN. If there is a match, client system 120 is deemed to have authenticated successfully with user device 230. Control passes to step 515 if authentication is successful (value “YES”) and to step 550 otherwise.

In step 515, client system 120 checks if pairing with user device 230 is successful. Referring to FIG. 6A, pairing is achieved by using association request 620 and association response 630, using the respective frames in accordance with IEEE 802.11 protocol, as is well known in the relevant arts. Control passes to step 520 if pairing is successful (value “YES”) and to step 550 otherwise.

In step 520, client system 120 sends rescue password request to user device 230 using rescue password request 630 as shown in FIG. 6A. Rescue password request 630 may contain connection details for connecting to central server 130 and the unique identifier of client system 120. User application 340 on user device 230 communicates (using rescue password request 635) the rescue password request to central server 130 via network 110 using the connection details provided by client system 120.

Central server 130 validates the unique identifier of client system 120 along with coupled user device 230. In other words, central server 130 may process a rescue password request originating from client system 120 only if such a request is communicated via user device 230 coupled with client system 120.

Upon successful validation, central server 130 retrieves the rescue password associated with client system 120 and sends the rescue password using rescue password response 640 to user device 230. User device 230 in turn sends the rescue password to client system 120 using rescue password response 645. Control passes to step 525.

In step 525, client system 120 receives the rescue password from user device 230.

In step 530, pre-boot module 310 performs pre-boot authentication using the rescue password. Specifically, pre-boot module 310 uses the received rescue password to decrypt row 412 in table 400. If the decrypted value matches with the disk-encryption-key retrieved from data store 360, pre-boot module 310 concludes that the request is received from an authorized user.

In step 535, pre-boot module 310 continues with the booting process. Thus, pre-boot module 310 may decrypt the software instructions representing the operating system using the disk-encryption-key and may then invoke an execution module that executes the decrypted software instructions in an execution environment (e.g. random access memory). Thus, the operating system is made operational, which thereafter permits client system 120 to perform normal intended operations (e.g., running of user applications).

After successful boot, client system 120 communicates the details for recovery initiation (e.g. invalid-password-counter exceeding threshold, user initiated recovery without invalid-password-counter exceeding threshold, type of user who was trying to boot—super user or limited user, etc) to central server 130 via network 110. Client system 120 may reset invalid-password-counter to zero in case the counter has exceeded the threshold. Client system 120 may also provide a suitable user interface for resetting the password. When the user provides a new password, the new password may be used to encrypt the disk-encryption-key and the corresponding row may be updated in table 400. The flowchart ends in step 550.

In this manner, client system 120 operates in conjunction with user device 230 to aid recovery from lost password using rescue password in the first example approach.

It may be appreciated that the rescue password is used to aid recovery from lost credentials without actually revealing the rescue password to the user. When the rescue password is revealed to the user (e.g. when super user communicates the rescue password to the limited user in case there is no network connectivity to central server 130), then the intermediate-key, the corresponding intermediate-key-hash, disk-encryption-key and the rescue password may be re-generated. The hard disk may first be decrypted using the old disk-encryption-key and re-encrypted with the new disk-encryption-key. The new rescue password may be communicated to central server 130 and the corresponding row in table 400 on client system 120 may be updated.

It may also be appreciated that user device 230 provides connectivity between client system 120 and central server 130 even during pre-boot durations, thus eliminating a need for administrator-assisted recovery from lost credentials.

The description is continued to illustrate an alternative approach to recovery from lost password according to aspects of the present disclosure.

### 7. Recovery from Lost Password Using Personal Identification Profile

In an embodiment, a personal identification profile of a user may be used for recovery from lost password. The personal identification profile of the user may include (but not limited to) biometric information (such as voice, face and/or fingerprints) of the user.

As part of configuring client system 120 for a user, the biometric information of the user may be provided a priori to client system 120 by user device 230. Such biometric information may be collected by user device 230 in a well known manner and sent to client system 120. Client system 120 may generate a profile-hash of the biometric information and use the profile-hash as encryption key to encrypt the disk-encryption-key noted above. Client system 120 may store the profile-hash in data store 360 and the resultant cipher data in table 400.

When the password of a user is unavailable (lost or forgotten), the user may indicate to client system 120 to retrieve the personal identification profile for pre-boot authentication via a suitable user interface.

FIGS. 5B and 6B together illustrate the manner by which recovery from lost password is implemented using personal identification profile of user. Specifically, FIG. 5B is a flowchart illustrating the approach for recovery from lost password using personal identification profile. FIG. 6B is a frame flow diagram illustrating the corresponding sequence of interactions for such recovery. Element 650 in FIG. 6B depicts the timeline for the sequence of interactions. All communication frames between client system 120 and user device 230 may be sent/received via WLAN interface 330 on client system 120 and WLAN interface 350 on user device 230.

As noted above, the flowchart and frame flow diagram are described with respect to the systems of FIGS. 2 and 3 merely for illustration.

The flow chart of FIG. 5B begins in step 551 upon receiving an indication from the user that the personal identification profile needs to be retrieved from user device 230, in which control immediately passes to step 555.

Steps 555, 560 and 565 of FIG. 5B correspond respectively to steps 505, 510 and 515 of flowchart of FIG. 5A and are not repeated here for conciseness.

Similarly, interactions 655, 660, 661, 665 and 666 of FIG. 6B correspond respectively to interactions 605, 610, 615, 620 and 625 of FIG. 6A and are not repeated here for conciseness.

In step 570, client system 120 sends personal identification profile request to user device 230 using personal identification profile request 670 as shown in FIG. 6B. Personal identification profile request 670 may contain the unique identifier of client system 120.

Upon receiving personal identification profile request 670 from client system 120, user application 340 on user device 230 may first seek consent from central server 130 before providing the personal identification profile to client system 120. Thus, user device 230 sends OTP request 672 to central server 130 via network 110. OTP request 672 may contain the unique identifier of client system 120.

As noted above in the description with respect to FIGS. 5A and 6A, central server 130 validates the unique identifier of client system 120 along with coupled user device 230. Upon successful validation, central server 130 generates an OTP in a well known manner and sends the OTP using OTP response 673 to user device 230. User application 340 on user device 230 validates the OTP (OTP validation 675) received from central sever 130 (e.g. using synchronized OTP-generation approaches, as is well known in the relevant arts)

Once OTP has been validated successfully (consent is received from central server 130), user application 340 collects the current biometric information of the user. For example, a voice profile may be collected using a microphone attached to user device 230, a face profile may be collected using a camera attached to the user device 230 and a fingerprint profile may be collected using a fingerprint scanner attached to user device 230. User device 230 then sends the biometric information to client system 120 using personal identification profile response 685. Control passes to step 575.

In step 575, client system 120 receives the personal identification profile from user device 230.

In step 580, pre-boot module 310 performs pre-boot authentication using the personal identification profile. Specifically, pre-boot module 310 uses the received biometric information to generate a hash and compares the generated hash with the profile-hash retrieved from data store 360. Upon a certain threshold percentage match (e.g. 80%), pre-boot module 310 may decrypt the corresponding row in table 400. If the decrypted value matches with the disk-encryption-key retrieved from data store 360, pre-boot module 310 concludes that the request is received from an authorized user. Control passes to step 585.

In step 585, pre-boot module 310 continues with the booting process. After successful boot, client system 120 communicates the details for personal identification profile request (e.g. invalid-password-counter exceeding threshold, user initiated recovery without invalid-password-counter exceeding threshold, type of user who was trying to boot—super user or limited user, etc) to central server 130 via network 110. As noted above, client system 120 may permit the user to reset the password. Client system 120 may also reset the invalid-password-counter. The flowchart ends in step 599.

Thus, central system 130 operates in conjunction with user devices associated with client systems 120 for convenient recovery from lost credentials for pre-boot authentication.

It may be appreciated that user device 230 performs an additional check of confirming with central server 130 when an personal identification profile request is received from client system 120 via OTP request-receive-validate process as described above. This may be especially useful in certain scenarios. For example, on the last working day of an employee in an enterprise, admin may communicate to central server 130 to disable access to client system 130 and additionally mark personal identification profile as a mandatory credential to boot client system 120. Thus, when the employee tries to boot client system 120, central server 130 may deny OTP request received from user device 230 coupled with client system 120. In this manner, central server 130 operates in conjunction with user device 230 to secure client system 120.

In an embodiment, recovery from lost password using personal identification profile may be available to the user only when recovery using rescue password exceeds a threshold number of failed attempts. Thus, an example recovery sequence may be as follows: on the first 10 failed attempts of trying to boot using password provided by user, the master password and additional passwords may be locked (unavailable for use during pre-boot authentication). Recovery from lost password may then be achieved using rescue password. On the next 10 failed attempts of recovery using rescue password, recovery using personal identification profile only may be available. On the next 10 failed attempts of recovery using personal identification profile, user initiated recovery may not be possible. Pre-boot module 310 may then make all data on secondary storage on client system 120 unreadable, thus making it nearly impossible to recover by user. Such data may only be possible to recover using assistance from a centralized laboratory, as will be apparent to a skilled practitioner.

In an embodiment, a virtual bridge interface may be established between client system 120 and user device 230 at the physical layer of networking, thus facilitating the use of user device 230 as an extended physical device for client system 120.

The description is continued to illustrate the manner in which user device 230 may aid central server 130 to keep track of geographical location of client system 120, which may be employed as an additional security measure.

### 8. Location Tracking Using User Device

In an embodiment, user device 230 may be employed as a location tracker for client system 120. Each time client system 120 is booted, client system 120 may communicate with user device 230 in the pre-boot duration as described above. User application 340 on user device 230 may send the location details (such as the GPS location, triangulation data and the nearest landmark) to central server 130 prior to pre-boot authentication. Central server 130 may store the location details of client system 120. For example, a user may boot client system 120 from his/her office location and also from home location. Both location details may be stored on central server 130.

In an embodiment, prior to pre-boot authentication, when a current location of client system 120 does not match an expected location (based on previous locations), central server 130 may employ additional checks to permit the boot process to continue. For example, central server 130 may communicate to client system 120 (via user device 230) to challenge the user for an OTP and a personal identification profile, in addition to the password. Thus, enhanced security measures may be implemented by central server 130 with the aid of user device 230.

It should be appreciated that the features described above can be implemented in various embodiments as a desired combination of one or more of hardware, software, and firmware. The description is continued with respect to an embodiment in which various features are operative when the software instructions described above are executed.

### 9. Digital Processing System

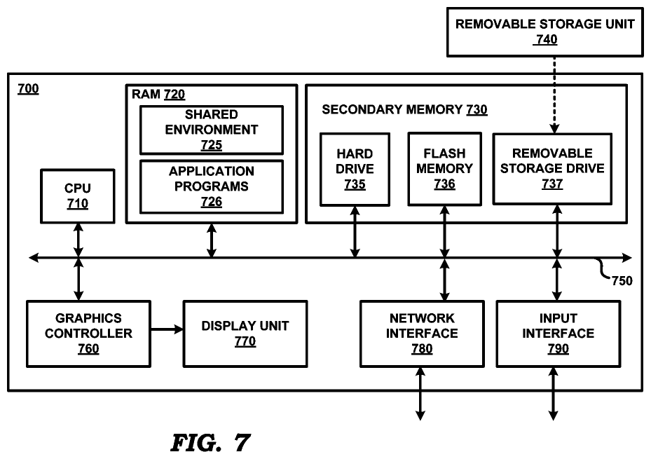

FIG. 7 is a block diagram illustrating the details of digital processing system 700 in which various aspects of the present disclosure are operative by execution of appropriate executable modules. Digital processing system 700 may correspond to one of client system 120.

Digital processing system 700 may contain one or more processors such as a central processing unit (CPU) 710, random access memory (RAM) 720, secondary memory 730, graphics controller 760, display unit 770, network interface 780, and input interface 790. All the components except display unit 770 may communicate with each other over communication path 750, which may contain several buses as is well-known in the relevant arts. The components of FIG. 7 are described below in further detail.

CPU 710 may execute instructions stored in RAM 720 to provide several features of the present disclosure. CPU 710 may contain multiple processing units, with each processing unit potentially being designed for a specific task. Alternatively, CPU 710 may contain only a single general-purpose processing unit. In addition, CPU 710 may be supported by CAM (content addressable memory) structures for examination of complex patterns.

RAM 720 may receive instructions from secondary memory 730 using communication path 750. RAM 720 is shown currently containing software instructions constituting shared environment 725 and/or other user programs 726 (such as the blocks of client system 120 or user device 230 shown in FIG. 3). In addition to shared environment 725, RAM 720 may contain other software programs such as device drivers, virtual machines, etc., which provide a (common) run time environment for execution of other/user programs.

Graphics controller 760 generates display signals (e.g., in RGB format) to display unit 770 based on data/instructions received from CPU 710. Display unit 770 contains a display screen to display the images defined by the display signals. Input interface 790 may correspond to a keyboard and a pointing device (e.g., touch-pad, mouse) and may be used to provide inputs. Network interface 780 provides connectivity to a network (e.g., using Internet Protocol), and may be used to communicate with other systems (of FIG. 2) connected to the networks (110).

Secondary memory 730 may contain hard drive 735, flash memory 736, and removable storage drive 737. Secondary memory 730 may store the data (for example, data shown in FIG. 4) and software instructions (for example, for implementing the various features of the present disclosure as shown in FIGS. 5A-5B, etc.), which enable digital processing system 700 to provide several features in accordance with the present disclosure. The code/instructions stored in secondary memory 730 may either be copied to RAM 720 prior to execution by CPU 710 for higher execution speeds, or may be directly executed by CPU 710.

Some or all of the data and instructions may be provided on removable storage unit 740, and the data and instructions may be read and provided by removable storage drive 737 to CPU 710. Removable storage unit 740 may be implemented using medium and storage format compatible with removable storage drive 737 such that removable storage drive 737 can read the data and instructions. Thus, removable storage unit 740 includes a computer readable (storage) medium having stored therein computer software and/or data. However, the computer (or machine, in general) readable medium can be in other forms (e.g., non-removable, random access, etc.).

In this document, the term “computer program product” is used to generally refer to removable storage unit 740 or hard disk installed in hard drive 735. These computer program products are means for providing software to digital processing system 700. CPU 710 may retrieve the software instructions, and execute the instructions to provide various features of the present disclosure described above.

The term “storage media/medium” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage memory 730. Volatile media includes dynamic memory, such as RAM 720. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 750. Transmission media can also take the form of acoustic or light waves, such as those generated during radio-wave and infra-red data communications.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Furthermore, the described features, structures, or characteristics of the disclosure may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the disclosure.

### 10. Conclusion

While various embodiments of the present disclosure have been described above, it should be understood that they have been presented by way of example only, and not limitation. Thus, the breadth and scope of the present disclosure should not be limited by any of the above-described exemplary embodiments, but should be defined only in accordance with the following claims and their equivalents.

It should be understood that the figures and/or screen shots illustrated in the attachments highlighting the functionality and advantages of the present disclosure are presented for example purposes only. The present disclosure is sufficiently flexible and configurable, such that it may be utilized in ways other than that shown in the accompanying figures.

Further, the purpose of the following Abstract is to enable the Patent Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present disclosure in any way.

What is claimed is:

1. A method performed in a digital processing system, said method comprising:
receiving, in a pre-boot duration, an indication from a user to retrieve a credential required for booting said digital processing system;
connecting, in said pre-boot duration, to a user device;
retrieving, in said pre-boot duration, said credential from an external server using said user device; and
continuing with a booting process after receipt of said credential.

2. The method of claim 1, wherein software instructions representing an operating system are stored in an encrypted format as a first cipher data on a secondary storage, said method further comprising:
decrypting said first cipher data utilizing said credential to generate said software instructions; and
executing said decrypted software instructions to have operating system be operational in said digital processing system.

3. The method of claim 2, wherein upon initialization of said digital processing system a BIOS (basic input/output system) software performs said receiving, said connecting, said retrieving, said decrypting of said first cipher data, and completes said booting to cause said operating system to be operational.

4. The method of claim 3, wherein said credential is a rescue password, further comprising:
encrypting said software instructions using a first key as encryption key;
encrypting said first key using said rescue password as encryption key to generate a second cipher data;
wherein said decrypting first decrypts said first key by processing said second cipher data using said rescue password as a decryption key, and then processing said first cipher data using the decrypted first key as decryption key to generate said software instructions.

5. The method of claim 4, further comprising:
storing a plurality of cipher data in the form of a table, said plurality of cipher data including said second cipher data and a third cipher data,
wherein each cipher data of said plurality of cipher data represents encrypted form of said first key based on a corresponding password of a plurality of passwords,
wherein said third cipher data represents encrypted form of said first key using a normal password which can be entered by said user in said pre-boot duration for booting said digital processing system,
wherein said user provides said indication upon unavailability of said normal password to cause said rescue password to be retrieved and boot said digital processing system.

6. The method of claim 3, wherein said BIOS retrieves said credential, performs said decrypting and said executing without requiring further user input after receipt of said indication.

7. The method of claim 3, wherein said credential comprises a current biometric information of said user, wherein said retrieving comprises:
authenticating said user device with said digital processing system;
receiving said current biometric information of said user from said user device, wherein said user device acquires and provides said current biometric information to said digital processing system only after receipt of a consent from said central server based on confirmation that said digital processing system is paired to said user device,
checking whether said current biometric information matches a prior biometric information of said user stored on said digital processing system, wherein said booting is continued if there is a match.

8. A non-transitory machine readable storage medium storing one or more sequences of instructions, wherein execution of said one or more instructions by one or more processors contained in a digital processing system enables the digital processing system to perform the actions of:
receiving, in a pre-boot duration, an indication from a user to retrieve a credential required for booting said digital processing system;
connecting, in said pre-boot duration, to a user device;
retrieving, in said pre-boot duration, said credential from an external server using said user device; and
continuing with a booting process after receipt of said credential.

9. The non-transitory machine readable storage medium of claim 8, wherein software instructions representing an operating system are stored in an encrypted format as a first cipher data on a secondary storage, said method further comprising:
decrypting said first cipher data utilizing said credential to generate said software instructions; and
executing said decrypted software instructions to have operating system be operational in said digital processing system.

10. The non-transitory machine readable storage medium of claim 9, wherein upon initialization of said digital processing system a BIOS (basic input/output system) software performs said receiving, said connecting, said retrieving, said decrypting of said first cipher data, and completes said booting to cause said operating system to be operational.

11. The non-transitory machine readable storage medium of claim 10, wherein said credential is a rescue password, further comprising:
encrypting said software instructions using a first key as encryption key;
encrypting said first key using said rescue password as encryption key to generate a second cipher data;
wherein said decrypting first decrypts said first key by processing said second cipher data using said rescue password as a decryption key, and then processing said first cipher data using the decrypted first key as decryption key to generate said software instructions.

12. The non-transitory machine readable storage medium of claim 11, further comprising:
storing a plurality of cipher data in the form of a table, said plurality of cipher data including said second cipher data and a third cipher data,
wherein each cipher data of said plurality of cipher data represents encrypted form of said first key based on a corresponding password of a plurality of passwords,
wherein said third cipher data represents encrypted form of said first key using a normal password which can be entered by said user in said pre-boot duration for booting said digital processing system,
wherein said user provides said indication upon unavailability of said normal password to cause said rescue password to be retrieved and boot said digital processing system.

13. The non-transitory machine readable storage medium of claim 10, wherein said BIOS retrieves said credential, performs said decrypting and said executing without requiring further user input after receipt of said indication.

14. The non-transitory machine readable storage medium of claim 10, wherein said credential comprises a current biometric information of said user, wherein said retrieving comprises:
authenticating said user device with said digital processing system;
receiving said current biometric information of said user from said user device, wherein said user device acquires and provides said current biometric information to said digital processing system only after receipt of a consent from said central server based on confirmation that said digital processing system is paired to said user device,
checking whether said current biometric information matches a prior biometric information of said user stored on said digital processing system, wherein said booting is continued if there is a match.

15. A digital processing system comprising:
a random access memory (RAM) to store instructions;
one or more processors to retrieve said instructions and execute said instructions, wherein execution of said instructions causes said digital processing system to perform the actions of:
receiving, in a pre-boot duration, an indication from a user to retrieve a credential required for booting said digital processing system;
connecting, in said pre-boot duration, to a user device;
retrieving, in said pre-boot duration, said credential from an external server using said user device; and
continuing with a booting process after receipt of said credential.

16. The digital processing system of claim 15, wherein software instructions representing an operating system are stored in an encrypted format as a first cipher data on a secondary storage, said method further comprising:
decrypting said first cipher data utilizing said credential to generate said software instructions; and
executing said decrypted software instructions to have operating system be operational in said digital processing system.

17. The digital processing system of claim 16, wherein upon initialization of said digital processing system, a BIOS (basic input/output system) software performs said receiving, said connecting, said retrieving, said decrypting of said first cipher data, and completes said booting to cause said operating system to be operational,
wherein said BIOS retrieves said credential, performs said decrypting and said executing without requiring further user input after receipt of said indication.

18. The digital processing system of claim 17, wherein said credential is a rescue password, further comprising:
encrypting said software instructions using a first key as encryption key;
encrypting said first key using said rescue password as encryption key to generate a second cipher data;
wherein said decrypting first decrypts said first key by processing said second cipher data using said rescue password as a decryption key, and then processing said first cipher data using the decrypted first key as decryption key to generate said software instructions.

19. The digital processing system of claim 18, further comprising:
storing a plurality of cipher data in the form of a table, said plurality of cipher data including said second cipher data and a third cipher data,
wherein each cipher data of said plurality of cipher data represents encrypted form of said first key based on a corresponding password of a plurality of passwords,
wherein said third cipher data represents encrypted form of said first key using a normal password which can be entered by said user in said pre-boot duration for booting said digital processing system,
wherein said user provides said indication upon unavailability of said normal password to cause said rescue password to be retrieved and boot said digital processing system.

20. The digital processing system of claim 17, wherein said credential comprises a current biometric information of said user, wherein said retrieving comprises:
authenticating said user device with said digital processing system;
receiving said current biometric information of said user from said user device, wherein said user device acquires and provides said current biometric information to said digital processing system only after receipt of a consent from said central server based on confirmation that said digital processing system is paired to said user device,
checking whether said current biometric information matches a prior biometric information of said user stored on said digital processing system, wherein said booting is continued if there is a match.
